(19) United States
(12) Patent Application Publication
(10) Pub. No.: US 2025/0075433 A1
(43) Pub. Date: Mar. 6, 2025

(54) HYBRID FIRE RETARDANT INSULATION AND METHOD OF MAKING THE SAME

(71) Applicant: CLEANFIBER INC., Blasdell, NY (US)

(72) Inventors: Jonathan Strimling, Bedford, NH (US); Curtis Fischer, Harspwell, ME (US)

(73) Assignee: CLEANFIBER INC., Blasdell, NY (US)

(21) Appl. No.: 18/290,202

(22) PCT Filed: May 18, 2022
(86) PCT No.: PCT/US2022/029917

§ 371 Date: Nov. 10, 2023

Related U.S. Application Data
(60) Provisional application No. 63/190,220, filed on May 18, 2021.

(51) Int. Cl. D21H 21/34; D21C 9/00

(52) U.S. Cl. CPC D21H 21/34; D21C 9/001

(57) ABSTRACT

A hybrid insulation product and related method for making the insulation product. The insulation product includes one or more feedstock components that may include one or more cellulosic feedstock components, wherein a first portion of the one or more feedstock components is treated with wet fire retardancy material, and a second portion of the one or more feedstock components is treated with dry fire retardancy material. The one or more feedstock components may include in addition to one or more cellulose feedstocks. one or more agricultural fiber sources.

### BACKGROUND OF THE INVENTION

### 1. Field of the Invention

The present invention relates to making fire retardant materials. More particularly, the present invention relates to making fire retardant insulation. Still more particularly, the present invention relates to insulation made with cellulosic material treated for fire retardancy using a combination of wet and dry fire retardancy material application.

### 2. Description of the Prior Art

Insulation is widely used for passive thermal control in a broad range of applications, with building insulation being a particularly substantial application. Inorganic fiberglass has been the most common type of material used to make insulation. Fiberglass insulation is provided in blanket and blown fiber form, with the thickness, density, and fiber structure of the blanket or the blown fiber fill determinative of insulative effectiveness, along with the method of installation also impacting effectiveness.

Concerns over the in-situ (installed) effective performance of fiberglass as well as the product's limited fire-retardant characteristics and environmental characteristics, which are regulated under the Federal National Toxicological standards, have raised public and governmental concerns over its continued use as a thermal insulation product. Organic cellulosic insulation has been considered as one type of alternative to fiberglass and can be desirable for that purpose, particularly for its environmental suitability and thermal efficiency. Some cellulosic insulation is made from recycled feedstock, with recycled newsprint being the primary feedstock. Other types of materials, such as cardboard, wood construction debris and the like, have been considered to increase the volume of available feedstock to produce cellulose-based insulation as recycled newsprint availability has declined.

Cellulose insulation is made in part using existing papermaking machinery and methods. Specifically, cellulose feedstock in the form of used paper, ordinarily in the form of printed newspaper, is ground, chopped or otherwise mechanically made into small pieces. In order to ensure that the cellulosic insulation conforms to fire retardant standards, the pieces combined with a fire-retardant chemical, which is usually a chemical in powder (i.e., solid) form. The powder must be adhered to the fibers and existing methods of adhering the chemical powder to the fiber, which may include mechanical impingement and/or using an oil to improve adherence have limited effectiveness. Examples of such fire-retardant chemicals include boric acid, borax, ammonium sulfate, monoammonium phosphate, diammonium phosphate, sodium tetraborate, ferrous sulfate, zinc sulfate, magnesium sulfate and mixtures thereof. The treated pieces may then optionally be fiberized, fluffed, or reduced in size to reduce the treated insulation's overall bulk density and improve its suitability for introduction into the structure to be insulated.

The adoption of cellulose insulation as an alternative to fiberglass insulation has been limited for several reasons. First, the cost of fabrication has limited the applications where it is economically competitive. Second, the conventional recycled material used as feedstock is not adequate to produce enough material to meet market demand as a replacement for fiberglass. In addition, the method of converting various types of recycled feedstock can significantly affect the processing cost. Third, the method of joining the fire-retardant material to the cellulose pieces requires the use of a considerable amount of the treatment material. In the case of powdered treatment material, there are challenges in getting the powdered treatment material to adhere to the fibers. There is often an excess of fire retardant material used, which can result in excess dust during installation as well as higher manufacturing costs. When the material is applied at a construction site by installers, a portion of the fire retardants becomes airborne and can become an irritant that can also limit visibility. A cellulose-based insulation using only dry fire retardancy material application has certain limitations and does not result in as effective an insulation product as the hybrid insulation described herein.

Several products and related processes have been described and developed to address the perceived limitations on the manufacture of a viable cellulosic insulation material. U.S. Pat. Nos. 5,534,301 and 6,025,027 to Shutt and U.S. Pat. Nos. 4,386,119 and 4,454,992 to Draganov describe the use of liquid borate to reduce the amount of borate needed to cover cellulose insulation fibers. However, the processes described in those patents involve the application of the liquid borate to dry fibers. This method is of limited commercial value and may not adequately address the difficulty in joining the fire-retardant chemical to the fibers. In addition, using liquid borates can cause embrittlement and breaking of the fibers, which increases the dustiness of the finished product and can adversely impact the product's density and insulation value. More recently, in U.S. Pat. No. 9,045,605, a process is described for reducing the dust associated with the manufacture of a fire-retardant cellulose insulation material in which cellulose material that has been sprayed with liquid fire-retardancy chemicals and dried and then screened so that the end product is less dusty. In the process, individual fibers are separated from each other in a dry state, which causes the undesirable fracture of relatively brittle fibers and the formation of excess dust. In addition, fire-retardant chemicals are contained in downstream dust that is removed from the finished product, and so, valuable fiber and flame retardants are lost to the finished product. That process is costly and less effective at generating a cellulose insulation material with satisfactory fire retardancy than exists with the present invention. A cellulose-based insulation using only wet fire retardancy material application also has a different set of limitations and does not result in as effective an insulation product as the hybrid insulation described herein.

Therefore, what is needed is a method for making fire-retardant cellulosic insulation in a cost competitive way. What is also needed is such a method that can be used with new feedstocks instead of, or in addition to, conventional material (including, for example, corrugated cardboard and recycled newsprint). Further, what is needed is a method to improve the fire-retardant chemical application method for fire-retardant chemical retention on and in the cellulosic material and to minimize inclusion of dust in the final product. The insulation should be made to minimize the negative characteristics of only dry-applied fire retardancy material and only wet-applied fire retardancy material while maintaining the positive advantages of such fire retardancy material application methods.

### SUMMARY OF THE INVENTION

It is an object of the present invention to provide a fire-retardant cellulosic insulation and related method for making the same in a cost competitive way. It is also an object to provide such an insulation and method that can be formed of, and used with, new feedstocks instead of, or in addition to, conventional material (including, for example, corrugated cardboard and recycled newsprint). Further, it is an object of the invention to provide an improved fire-retardant chemical application method for fire-retardant chemical retention on and in the cellulosic material and to minimize inclusion of dust in the final product. The insulation may be made to minimize the negative characteristics of only dry-applied fire retardancy material and only wet-applied fire retardancy material while maintaining the positive advantages of such fire retardancy material application methods.

These and other objects are achieved with the present invention, which is a hybrid insulation product including cellulose-based feedstock components, where a portion of the insulation is treated with wet fire retardancy materials and a portion of the insulation is treated with dry fire retardancy materials in wet and dry conditions, a method for making such a fire-retardant cellulosic material based insulation, and a system for making that insulation. The insulation includes a portion wet-treated for fire retardancy and a portion only dry-treated for fire retardancy. The terms “wet” and “liquid” may be used interchangeably herein to mean fire retardancy material that is moistened, damp, or in a form that flows freely. The term “dry” means fire retardancy material that is substantially free of moisture (meaning that it is in powder or similar solid form, rather than dissolved in a freely flowing liquid). The feedstock may be an inorganic material but may also be an organic material, which organic material may be preferable to avoid limitations and possible safety concerns associated with inorganic material. The method is suitable for use in making an insulation product from one or more feedstocks. The one or more feedstocks may include one or more recycled cellulosic feedstock, one or more virgin pulp feedstocks, one or more agricultural fiber sources, and combinations thereof. The amount and type of recycled material and/or virgin material are selectable. Virgin feedstock may be used to make up the amount of pulp required to fill insulation orders dependent upon the availability of recycled material feedstock. Old newsprint (ONP) may be one type of recycled material feedstock. Other suitable types of cellulose material feedstock include old corrugated containers (OCC), corrugated board, liner board, recycled cellulose, virgin kraft, pulp, virgin ground wood pulp, sawdust, wood chips, pine chips, and combinations thereof. The invention is not limited to just these two recycled material feedstocks. Additional fiber feedstocks could include sources of agriculturally derived fibers, such as cereal, straw, animal feathers, rice hulls, hemp, wheat, and combinations thereof, and other lignocellulosic agricultural byproducts. The invention may include the use of a single feedstock of either type or any other type, provided its characteristics are accounted for in the process of combining it with a fire retardancy chemical. A portion of the feedstock is treated while in a liquid environment for fire retardancy, and the remaining portion of the feedstock is treated with dry fire retardancy material. The two portions are combined together after the portion treated in a liquid environment has completed a drying process. The ratio of liquid treated feedstock to dry treated feedstock may range from about 90% wet processed to about 10% dry processed to about 10% wet processed to about 90% dry processed.

A system of the present invention includes components configured to carry out steps of a method for treating feedstock with fire retardancy material in a wet environment, components for treating feedstock with fire retardancy material in a dry environment, and components for combining the two treated feedstock portions together. The wet treatment components include a wet treatment feedstock source and a chemical treatment source with an input component. The chemical treatment source includes a liquid solution or suspension of treatment material, which may be a combination of a fire retardancy chemical, such as a borate or other suitable compound or a combination of such compounds, at least one solvent such as water, and other optional additives that may be of interest. It is to be understood that an array of suitable fire retardancy chemicals may be employed to treat the cellulosic material. For example, boric acid, borax, poly-hydrated boron compounds, calcium sulfate, ammonium sulfate, monoammonium phosphate, diammonium phosphate, sodium tetraborate, ferrous sulfate, zinc sulfate, magnesium sulfate, and mixtures thereof are suitable. The chemical treatment materials may be dissolved or suspended in the at least one solvent. An aspect of the invention is that the fire retardancy chemical is combined with a portion of the feedstock in a liquid form rather than a solid form to provide effective attachment of the fire retardancy chemical to the surface of and into the basic structure of the feedstock component. More specifically, the fire retardant may be allowed to diffuse into external surface of the fibers of the feedstock and/or to diffuse into the core of the fibers in the wet-treatment portion of the invention.

One or more other additives may be incorporated into the wet treatment portion of the method for making the insulation of the present invention. For example, a chemical, biological or other additive may be used to eliminate or reduce one or more components of the feedstock that may result in a product with undesirable characteristics. For example, a cellulosic feedstock that is a recycled material may include one or more bonding agents comprising polysaccharides, starches, and the like that, if carried through to the end product, may facilitate mold growth. An additive such as an enzyme or other component to break down such undesirable components, and/or make them sufficiently fluidized and/or separated that they can be removed from the treated feedstock, may be added to the blend tank as an aspect of the present invention. A biocide may be added to minimize mold growth. Other additives include, but are not limited to, one or more fungicides, one or more lubricants, one or more bonding agents, and combinations of any of these and other additives.

The liquid/wet chemical treatment source is combined with the plurality of fibers at one or more selectable stages of the cellulose insulation fabrication method prior to drying of the wet-treated cellulose material. For example, the input component for the chemical treatment source may be coupled to the blend tank for introduction of the chemical treatment at that point of the method, when the fibers are suspended in a mostly liquid state. However, it is to be understood that the input component for the chemical treatment source may be located elsewhere, including other system component locations provided it is in liquid form when in contact with the cellulose feedstock. Examples of alternative processing steps include the application of a liquid fire retardant in the mixing stage (after partial dewatering) and/or spraying of dried paper with a liquid fire retardant.

The dry treatment components of the system include a dry treatment feedstock source and a dry chemical treatment source with an input component. The dry treatment feedstock source may be the same as or different from the wet treatment feedstock source. The chemical treatment source includes one or more fire retardancy materials in dry form. For example, boric acid, borax, ammonium sulfate, monoammonium phosphate, diammonium phosphate, sodium tetraborate, ferrous sulfate, zinc sulfate, magnesium sulfate, and mixtures thereof are suitable. An aspect of the invention is that the fire retardancy chemical is combined with a portion of the feedstock in a dry form rather than a liquid form to provide effective attachment of the fire retardancy chemical to the surface of the feedstock component.

It is noted that the dry feedstock portion of the insulation of the present invention may be simply recycled or virgin paper or fiber feedstocks in dry form. Alternatively, the dry feedstocks may be processed for other characteristics prior to being dried and then being treated with the dry fire retardancy material. For example, a chemical, biological or other additive may be used to eliminate or reduce one or more components of the feedstock that may result in a product with undesirable characteristics. For example, a cellulosic feedstock that is a recycled material may include one or more bonding agents comprising polysaccharides, starches, and the like that, if carried through to the end product, may facilitate mold growth. An additive such as an enzyme or other component to break down such undesirable components, and/or make them sufficiently fluidized and/or separated that they can be removed from the treated feedstock, may be added to a blend tank as an aspect of the system of the present invention prior to drying and fire retardancy treatment. A biocide may be added to that blend tank to minimize mold growth.

The dry chemical treatment source is combined with the plurality of dry fibers at one or more selectable stages of the cellulose insulation fabrication method. For example, an output component of the dry chemical treatment source may be coupled to size reduction equipment that is processing the dry feedstock. Alternatively, an output component of the dry chemical treatment source may be coupled to the output of a drier so that processed and dried fibers of the dry feedstock may be mixed with the dry chemical treatment prior to final processing of the insulation material, either before mixing the dry-treated feedstock portion with the wet-treated feedstock portion or after that mixing has occurred. If dry chemistry is applied after mixing with the wet-treated feedstock portion, both the dry and the wet portions would have dry fire retardancy material applied to the exterior surfaces of the insulation fibers. If dry chemistry is applied solely to dry materials and then the dry treated dry feedstock is mixed with wet-treated feedstock(s), then some dry chemistry may also be applied in a final mixing process to some of the wet-treated feedstock.

The system of the present invention further includes conventional components including, but not limited to, one or more wet separation devices (including wet classification devices), dewatering devices, one or more water recovery and return devices, optional fiber dye and/or bleaching devices, one or more dryers, dust collectors, coolers, fluffers, fiberizers, dry classifiers, product collectors and all conduits required to transfer material among the devices of the system. The system may be substantially incorporated into a conventional pulp and fiber manufacturing process of the type typically used in the papermaking industry, for example, rather than as a completely distinct or an extensive add-on to a conventional process. Examples of devices of the system will be described herein, a number of which exist in the conventional pulp/paper processing facilities that currently exist.

The system may include a mechanism for separating fibers from one another prior to treatment with a fire retardant. Conventional pulping and screening systems from the paper processing industry may be utilized to separate fibers. The purpose of this step is to gently break down woven or formed fiber structures (such as paper) to unwind, decouple and free individual fibers. This may occur with the fiber while in a slurry state, where a liquid such as water is used as a medium to convey the fiber.

The system may also include one or more partitioning devices for separating the material stream into various component streams with different properties. For example, one partitioning device may separate heavy components like metals and glass from fiber; another partitioning device may separate longer fibers from shorter fibers. Partitioning devices that separate types of fiber from each other will also be referred to herein as classifiers. Cyclonic devices may be used for removing heavy elements from the fiber stream. Fiber screening devices may also or alternatively be utilized to partition fibers by fiber size. The partitioning system may include means to remove plastics and other products that may float when the fibers are suspended in a slurry.

The system and related method of the present invention provide an effective and cost competitive way to manufacture a viable cellulose insulation product. The method can be used to make other sorts of products that are fiber-based and that require treatment to establish desired characteristics. The separation of the fibers and the partitioning and/or classification of the fibers in a wet state avoids breakage of fibers, when compared with conventional dry processing. The introduction of the chemical treatment to the pulp prior to drying a portion of the feedstock yields a reduction in chemical treatment costs and overall insulation processing costs. The system and method provide for the option to use only recycled cellulosic material as feedstock or a combination of such feedstock with other materials to ensure an adequate and sustainable supply of feedstock.

The present invention enables the manufacture of fire-retardant insulation materials. The feedstock used to make the fire-retardant insulation material may be of any type not limited to specific paper, pulp, container, or other form of material. The invention provides for the combining of a fire retardancy chemical with a portion of the feedstock prior to drying of the combination. The fire retardancy chemical is in liquid form when combined with the wet-treatment portion of the feedstock, and in dry form when combined with the dry-treatment portion of the feedstock. The combination of fire retardancy chemical and the feedstock may be further processed to form a web, a sheet, or other structures comprised of a plurality of fibers. The feedstock and fire retardancy combination may be further processed to make insulation, as noted, or other end products wherein fire retardancy is a desirable feature.

Fibers that have been separated and/or partitioned in a wet state may be mixed in a moist or wet state with fibers obtained from other sources. For example, fibers from various feedstock sources may be mixed together in the wet state or other fibers may be mixed in dry. Recycled paper materials may be mixed with agricultural fibers and/or animal feathers. In addition, dust or smaller fiber fragments recovered from other stages of the production process may be mixed with separated classified fibers from earlier stages of processing. The mixture of various fiber sources and long and shorter fibers can aid in the formation of fiber superstructures that may optionally be created later in this process. Those superstructures may represent the agglomeration of fiber pieces that are otherwise too small to function as effective insulation. The agglomeration of fiber pieces may also be useful to reduce dust in the finished product, to improve the insulation properties of the finished product and/or to favorably impact the density of the finished product.

The hybrid fire retardancy chemical treatment of the present invention provides enhanced fire resistance. With dry chemistry, there is a minimum fire retardant loading level (typically 13-15%) that is required to meet industry regulatory tests for CRF and smolder. With wet chemistry, there is a minimum fire retardant level of 8-12% to meet the same regulatory tests. The combination of the wet and dry fire retardants yields a surprising result in that the required loading to meet regulatory tests can be lower than is required with either approach separately (in the range of 5-11%). The mechanics of the interactions between the wet treated and the dry treated materials are not fully understood in terms of a flame-spread chemistry and kinematics, but it appears that the two approaches function in unique and complementary ways to separately address issues of smolder in volumes and flame spread on surfaces It should be understood that the level of fire retardancy required for any particular blend of fibers may vary with the blend of fibers, and the hybrid fire retardancy chemical treatment may also allow for a broader range of fiber sources at an equivalent loading of fire retardant to conventional methods.

The hybrid fire retardancy chemical treatment also provides enhanced strength and fluffiness: With dry chemistry, there is a minimum achievable settled density, which is the density of the material after simulated settling via vibratory testing. With dry chemistry, this is typically about 1.5 lbs./cubic foot. With wet chemistry, there is also a minimum achievable settled density, often closer to 1.8 lbs./cubic foot. In each case, the minimum is set by processing methods that also have to provide sufficient fire resistance and resistance to thermal flow in the terms of R-value. The combination of the wet and dry fire retardants yields another surprising result: the minimum settled density that is achievable with a hybrid structure can be lower than for either purely wet-processed or purely dry-processed material and can be as low as 1.2 lbs./cubic foot. In addition, at a given level of loading of fire retardants, the hybrid fire retardancy chemical treatment approach may allow the product to meet a settled density requirement with a broader mix of fibers than could have been achievable solely with wet or dry fire retardant. Benefits of the hybrid combination of wet and dry fire retardancy treatments relative to dry alone or wet alone treatments include but may not be limited to: 1) enhanced fire resistance; 2) lower requirements for the total quantity of fire retardants; 3) improved coverage (in terms of the area covered by a given weight of fiber), which is inversely proportional to settled density; and 4) improved R value; and 5) an ability to utilize a broader mix of fibers. By combining the two portions, the proportions of which may range between about 90-20% wet processed fiber to about 10-80% dry processed fiber, it is possible to minimize the total fire retardancy material added to the combination while still meeting CRF and smolder requirements.

In addition, the combination of wet and dry chemistry and the consequent reduction in the loading of fire-retardant chemistry has three significant additional benefits. First, the reduction in the quantity of fire retardants reduces the relative proportion of inorganic matter to fiber, which means the fiber can be fluffier, covering a larger area for a given weight of fiber, trapping more air, and providing a higher R-value. Second, the dust levels of the product are reduced due to first a reduction in the amount of chemistry applied, and secondly because much of the chemistry is inside of fibers, rather than on the outside of fibers, as has been the case for conventional treated cellulose. Finally, the treatment of a portion of the fibers with dry chemistry allows those fibers to avoid the embrittlement that can be a result of treatment with wet chemistry In a fluffed condition as installed, the stronger dry-treated fibers can bear a disproportional amount of the mechanical loads associated with settling, when compared with the wet-treated fibers. So, in additional to the synergies in arresting the spread of fire, the hybrid wet and dry treatment approach also create unexpected mechanical synergies, with mechanical loads shifting from wet-treated fibers to dry-treated fibers.

The invention can be characterized as a hybrid fire retardant insulation product comprising one or more feedstock components, wherein a first portion of the one or more feedstock components is treated with wet fire retardancy material to integrate the wet fire retardancy material within fibers of the first portion of the one or more feedstocks, and a second portion of the one or more feedstock components is treated with dry fire retardancy material. Some of the one or more feedstock components of the second portion may be in a wet condition when treated with the dry fire retardancy material. The one or more feedstock components may include cellulose fibers that are wet when treated with the wet fire retardancy material. The wet cellulose fibers may contain between about 25% and about 75% by weight of moisture when treated with the wet fire retardancy material. The one or more feedstock components may include one or more cellulose feedstocks, one or more agricultural fiber sources and combinations thereof.

The one or more feedstock components may include cellulose fibers, wherein the cellulose fibers are sourced from one or more of corrugated board, liner board, Old Corrugated Containers, Old Newsprint, recycled cellulose, virgin kraft pulp, virgin ground wood pulp, sawdust, wood chips, pine chips, and combinations thereof. The one or more feedstock components may include agricultural fibers, wherein the agricultural fibers are sourced from one or more of straw, wheat, rice hulls, feathers, hemp, and combinations thereof. The wet fire retardancy material and the dry fire retardancy material may be selected from one or more of boric acid, borax, poly-hydrated boron compounds, sodium tetraborate, ammonium sulfate, magnesium sulfate, calcium sulfate, zinc sulfate, ferrous sulfate, and mixtures thereof. At least some of the one or more feedstock components of the second portion may be treated with a loading of the dry fire retardancy material of about 3% to about 20% by weight on a dry weight percent basis, including loading of about 5% to about 12% by weight. One or more additives may be included as part of the hybrid fire retardant insulation product, which one or more additives may be selected from the group consisting of one or more biocides, one or more enzymes, one or more fungicides, one or more lubricants, one or more bonding agents, or any combination thereof.

At least some of the one or more feedstock components of the second portion may be in a dry condition when treated with the dry fire retardancy material. At least some of the one or more feedstock components of the second portion in a dry condition may be treated with a dry fire retardancy material loading of about 3% to about 25% by weight on a dry weight percent basis, including about 7% to about 18% by weight. The one or more feedstock components may be a combination of dry treated feedstock and wet treated feedstock, with a ratio of dry treated feedstock to wet treated feedstock is in a range of about 10% to about 90% to about 90% to about 10% by weight.

The invention is also a method of producing the hybrid fire retardant insulation product comprising the steps of treating a first portion of the one or more feedstock components with wet fire retardancy material to integrate the wet fire retardancy material within fibers of the first portion of the one or more feedstocks, treating a second portion of the one or more feedstock components with dry fire retardancy material, drying the first portion of the one or more feedstock components after the step of treating with the wet fire retardancy material, and combining the treated and dried first portion with the treated second portion. The method may also include the step of treating at least a portion of the first portion of the one or more feedstock components with the dry fire retardancy material. The cellulose feedstock component may include cellulose fibers that are wet when treated with the wet fire retardancy material. The wet cellulose fibers may contain between about 25% and about 75% by weight of moisture when treated with the wet fire retardancy material. The one or more feedstock components may include one or more cellulose feedstocks, one or more agricultural fiber sources and combinations thereof. The cellulose feedstock component may be sourced from one or more of corrugated board, liner board, Old Corrugated Containers, Old Newsprint, recycled cellulose, virgin kraft pulp, virgin ground wood pulp, sawdust, wood chips, pine chips, and combinations thereof. The one or more feedstock components may include agricultural fibers, wherein the agriculture fibers are sourced from one or more of straw, wheat, rice hulls, feathers, hemp, and combinations thereof.

Further, for the method, the fire retardancy material may be selected from one or more of boric acid, borax, poly-hydrated boron compounds, sodium tetraborate, ammonium sulfate, magnesium sulfate, calcium sulfate, zinc sulfate, ferrous sulfate, and mixtures thereof. At least some of the one or more feedstock components of the second portion may be treated with a loading of the dry fire retardancy material of about 3% to about 20% by weight on a dry weight percent basis, including loading of about 5% to about 12% by weight. The method may also include the step of adding one or more additives to either or both of the first portion of the one or more feedstock components while treating with the wet fire retardancy material and the second portion of the one or more feedstock components while treating with the dry fire retardancy material. The one or more additives may be selected from the group consisting of one or more biocides, one or more enzymes, one or more fungicides, one or more lubricants, one or more bonding agents, or any combination thereof. At least some of the one or more feedstock components of the second portion may be in a dry condition when treated with the dry fire retardancy material. A ratio of dry treated feedstock to wet treated feedstock is in a range of about 10% to about 90% to about 90% to about 10% by weight.

### BRIEF DESCRIPTION OF THE DRAWINGS

FIG. 1 is a first simplified block diagram representation of method stages and system components associated with an example for manufacturing the hybrid fire retardant cellulose insulation of the present invention. Dashed lines represent optional features, components and/or steps.

FIG. 2 is a second simplified block diagram representation of method stages and system components associated with an example for manufacturing the hybrid fire retardant cellulose insulation of the present invention. Dashed lines represent optional features, components and/or steps,

### DETAILED DESCRIPTION OF EMBODIMENTS OF THE INVENTION

While the following description is directed to embodiments of the invention wherein a hybrid fire retardant cellulose insulation is made, it is to be understood that the invention is not limited thereto. Instead, the present invention is a method to produce the hybrid fire retardant cellulose insulation having adequate fire retardancy using one or more recycled cellulose-based feedstock material in a cost-effective way and the hybrid insulation that results from the method. The steps of the method described may be done in different orders without deviating from the scope of the invention including, but not limited to, the order in which components are added to a mixer, except that a portion of the insulation feedstock is only treated with fire retardancy material in a dry state while the remainder of the insulation feedstock is treated with fire retardancy material in a wet state. That remainder may also be treated with fire retardancy material in a dry state. While the insulation is referred to as a cellulose insulation, it is to be noted that other non-cellulose materials may be included as part of the insulation.

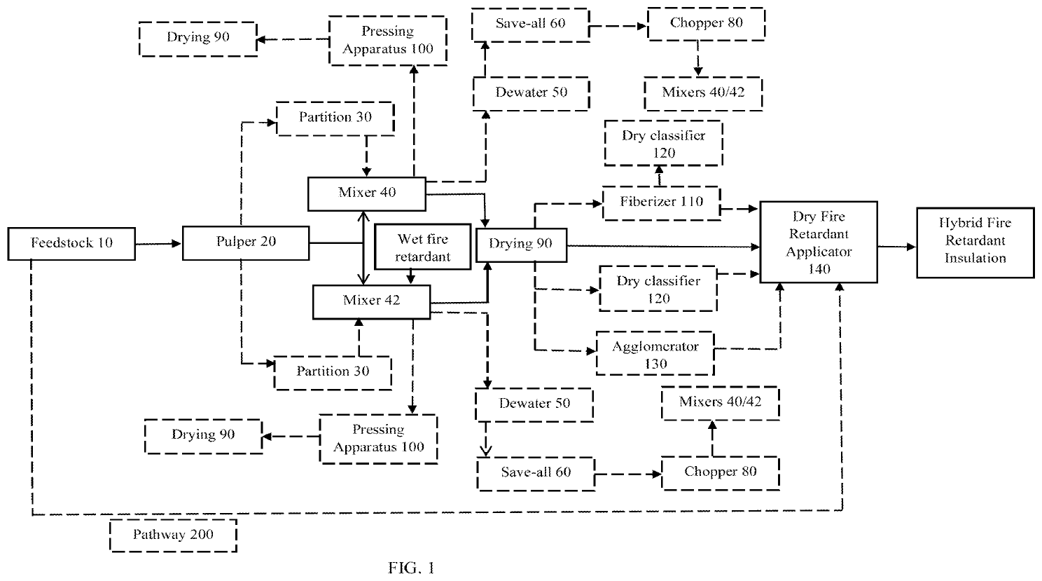

Referring to FIG. 1, an embodiment of the hybrid fire retardant cellulose insulation of the present invention is created when cellulose-based feedstock material that may or may not otherwise be recycled, waste, or other material, referred to herein as feedstock material 10, and/or other feedstock materials that may include virgin materials, and/or recovered materials produced in the method of the present invention, is/are combined with one or more fire retardancy chemical compounds to produce the insulation. The one or more feedstock materials are reduced to fiber form prior to or in conjunction with combining a portion thereof with one or more fire retardancy compounds in a dry environment, and the remainder with one or more fire retardancy compounds in a wet or liquid environment. The feedstock material 10 is transferred to a fiber generating apparatus such as a pulper 20, for example. Other means for generating fibers from the feedstock are known to those skilled in the art and may also include recovering dry fiber streams from downstream processes.

The pulper 20 may be utilized to separate fibers from one another. The agitation of fibers in the presence of a liquid such as water can be an effective means of separating the fibers to an extent. Pulp generated in the pulper 20 may optionally be transferred to a partitioning device 30 to remove contaminants and/or to classify fibers before introducing the fibers to a first mixer 40 and a second mixer 42. The partitioning device 30 may be a wet classification system, such as a screening system that separates fibers by fiber size. The partitioning device 30 may also be a cyclonic separator that separates heavy materials from lighter materials. The partitioning device 30 may also have multiple stages and multiple functions, such as combinations of cyclonic separators and screening systems, with the goal of separating fibers desired for one use from fibers desired for a different use and/or separating out waste materials.

A first portion of the separated fibers are transferred to mixer 40 for further processing that does not include processing of the fibers with the fire retardancy material in a wet environment. A second portion of the separated fibers are transferred to mixer 42 for further processing that does include processing of fibers with the fire retardancy material in a wet environment. Optionally, some of the fibers may be diverted to another application. The separated fibers may optionally be dewatered, at least partially, in dewatering apparatus 50 prior to introduction to the mixers 40 and 42, with effluent from the dewatering apparatus 50 transferred to a “save-all” tank 60 for the return of recovered wet fiber to the pulper 20. The at least partially dewatered separated fibers or the separated fibers that have not been dewatered are transferred directly to the mixers 40 and 42 or they may optionally be fluffed and/or chopped in apparatus 80 prior to introduction to the mixers 40 and 42. In addition, it is possible that the fibers are agitated within the mixers 40 and 42 by chopper blades or other mechanical action that may serve to further separate the fibers while still moist or wet. The fundamental function of the apparatus 80 is to separate the fibers in a wet state so that they are not clumped together but are predominantly separated. While the fibers may have been originally separated in an upstream pulping process, the process of dewatering under pressure can have the effect of binding fibers together, and the apparatus 80 can be useful in re-separating the fibers from one another. Because the apparatus 80 operates on fibers still in the wet state, breakage of the fibers is again minimized. If superstructures of fibers are present while material is being chopped, the apparatus 80 may be tuned to maintain the integrity of a specific scale of superstructures, while separating other larger clumps, for example.

One or more additives may be added to the mixer 40 before, during or after introducing the first portion of separated fibers to the mixer 40. The one or more additives may be used to enhance the characteristics of the separated fibers. For example, the additives may include one or more enzymes suitable to remove residual adhesive from the feedstock material 10. One or more bonding agents may also be added to the mixer 40 before, during or after introducing the separated fibers to the mixer 40. The one or more bonding agents may be selected to cause individual fibers to clump together and remain joined together. The bonding agents may be added at the mixer 40 or may be applied in downstream processes and may cause the joining to occur in the mixer 40 or at a downstream stage, such as during drying. The bonding between fibers may form fiber superstructures with interstices between the fibers that improve the insulative characteristics of the finished product. It is noted that an embodiment of the invention includes moving all or a portion of the first portion of the feedstock to dry fire retardancy application directly or after some physical modification but without wetting that feedstock portion.

Fibers exiting the mixer 40 are transferred to a drying apparatus 90 to be dried to a liquid content in the range of about 5% to about 25% by weight. Optionally, the fibers from the mixer 40 may first be pressed in a pressing apparatus 100. The pressing apparatus 100 may have the function of removing water, helping to form a plurality of superstructures, or both functions, before delivery to the drying apparatus 90. Optionally, the dried fibers may be fiberized in fiberizer 110. The dried fibers may further optionally be classified in dry classifier 120, either directly from the drying apparatus 90 or from the optional fiberizer 110. The purpose of the dry classifier 120 is to ensure that the properties of the finished product meet the targeted characteristics for size, density and/or hydrodynamic diameter. The dry classifier 120 may provide as outputs both the desired product and non-conforming materials, which may include dust (smaller than desired particles) or larger clumps (heavier than desired materials).

When the optional dry classifier 120 is employed, non-conforming materials such as small particles and dust, or large and heavy materials, may be removed from dried fibers and returned to either of mixers 40 and 42 or to another stage of the process. Dust may be returned for agglomeration when the one or more bonding agents are in the mixer 40 or 42 and/or the small particles and dust may be returned to one or more other apparatuses for reconstitution as fiber superstructure components of the finished end product. The small particles and dust may optionally be diverted to an agglomeration apparatus 130, which may simply be a dry mixer, for combining with one or more supplemental bonding agents and/or other supplemental fibers to form additional residual fiber superstructures that may be incorporated with the end product.

At any one or more stages of the method after drying of the first portion of fibers has occurred, the dried fibers are directed to dry fire retardancy material applicator 140, which may be a container, mixer, conveyor, or other substrate whereby one or more dry fire retardancy materials are directed to the exterior surfaces of the dried fibers. The process of applying and coating the dried fibers with fire retardancy material(s) may be similar to the process employed previously to treat insulation materials with fire retardancy materials. Following fire retardancy material application and any optional classification, at least a portion of the first portion of fibers is then in satisfactory form to be packaged for use as a portion of the finished end product such as the hybrid fire retardant cellulose insulation of the present invention.

In parallel with the processing of the first portion of fibers for dry fire retardancy material application, or before or after that processing, the second portion of separated fibers are mixed in the mixer 42 with one or more fire retardancy chemical compounds and one or more solvents. The one or solvents may be water, another liquid, or a combination of water and another liquid. The solvent may either be added to the mixer 42 or it may come with the separated fibers in the transfer from any one of the pulper 20, the partitioning device 30, the dewatering apparatus 50 and the fluffer/chopper apparatus 80. The one or more fire retardancy chemical compounds may be added to the mixer 42 before, during or after introducing the second portion of separated fibers to the mixer 42. Optionally, the one or more additives may be added to the mixer 42 before, during or after introducing the separated fibers to the mixer 42. The one or more bonding agents may also be added to the mixer 42 before, during or after introducing the second portion of separated fibers to the mixer 42. It is noted that an embodiment of the invention treats the second portion of feedstock with fire retardancy material in a wet or moist state outside of any pulping process, as well as outside of any slurry processing.

The second portion of separated fibers, the one or more fire retardancy chemical compounds, and any optional additives and/or bonding agents contained in the mixer 42 are mixed together for a sufficient amount of time for the fire retardancy chemical compounds to be retained on and in the separated fibers, and to enable sufficient fiber bonding to occur before completion of processing if it is a goal to form fiber superstructures in the mixer 42. Treated fibers exiting the mixer 42 are transferred to the drying apparatus 90 to be dried to a liquid content in the range of about 5% to about 25% by weight. Optionally, the treated fibers may first be pressed in the pressing apparatus 100. Optionally, the treated and dried fibers may be fiberized in the fiberizer 110. The treated and dried fibers may further optionally be classified the dry classifier 120, either directly from the drying apparatus 90 or from the optional fiberizer 110. Following optional classification, a selected subset of treated and dried fibers of the second portion of feedstock may then in satisfactory form to be packaged for use as a portion of the hybrid fire retardant cellulose insulation of the present invention.

At any one or more stages after drying of the second portion of fibers has occurred, the treated and dried fibers are directed to the dry fire retardancy material applicator 140 either in combination with the dried but not wet treated fibers from mixer 40 (or at least a portion of that first portion of feedstock moving directly to the applicator 140 without any sort of wet processing) or separately from that first portion of fibers. The process of applying and coating the treated and dried fibers with fire retardancy material(s) may be similar to the process employed previously to treat insulation materials with fire retardancy materials. Following fire retardancy material application and any optional classification, at least a portion of the second portion of treated fibers is then in satisfactory form to be packaged for use as a portion of the finished end product such as the hybrid fire retardant cellulose insulation of the present invention.

The feedstock material 10 may be comprised of one or more recyclable materials that are cellulose-based, including, but not limited to any plant-based materials. Additional fiber feedstocks suitable for use in the invention include sources of agriculturally derived fibers, such as cereal straw, animal feathers, and other lignocellulosic agricultural byproducts, for example. Virgin feedstock material may be from a kraft or a groundwood (stone or thermo-mechanical). The ratio of recycled material to virgin material and/or recovered wet fibers is selectable when the combination is used. The feedstock material(s) may be added to the partitioning device 30 at a level of 1% to 30% solids by weight.

As noted, the virgin feedstock material can be hardwood (1.5 mm), softwood (3.5 mm) (kraft process) or groundwood (<1 mm) (includes stone, thermo-mechanical process), and/or cellulose pulp fibers, which may be diverted from a conventional cellulose processing system prior to bleaching, or immediately afterward if that is of interest. Pulp coming off the last black liquor washer in a kraft process, for example, before going into the bleaching process (20% solid by weight) can be used. A pump may be used to move pulped fibers from the pulper 20 to the partitioning device 30. Those of skill in the art will recognize that any sort of material transfer mechanism may be used to move material including, but not limited to, pulped material from one location to another for the process of the present invention.

Recycled newsprint pulp may be obtained from a conventional paper recycle process, such as from ONP #8 and #9 sources, for example. The paper can be introduced into the pulper 20. The pulper 20 is a tank that has an agitator and a source of solvent, such as water, to pulp the feedstock. The agitation breaks down the cellulosic material into fiber stalks. The one or more fire retardants may be delivered to the mixer 42 in liquid form, such as by being dissolved in a solvent such as water. The fire retardants when combined with the second portion of fibers in a liquid environment are better adhered to the surface of and absorbed into the structure of the separated fibers than when dry fire retardancy chemicals are used and when liquid fire retardancy chemicals are simply sprayed onto feedstock rather than separated fibers. The fire retardant can be in a dry or a wet form combined with fiber in wet form, or it can be combined in dry or wet form with fibers and the one or more solvents. The one or more fire retardants may be selected from boric acid, borax, ammonium sulfate, monoammonium phosphate, diammonium phosphate, sodium tetraborate, ferrous sulfate, magnesium sulfate, zinc sulfate and mixtures thereof.

The chemical saturation, operating temperature, and dwell time in the mixer 42 is selectable to ensure that the finished cellulose insulation contains a sufficient amount of fire-retardancy material adhered in and to the fibers of the insulation. The one or more other additives may be used to hydrolyze starch, polysaccharide, or other undesirable materials, for example, as well as one or more biocides, as desired to minimize mold growth in the end product. The other additives and/or bonding agents may be mixed together before transfer to the mixers 40 and 42 such as with a mixing valve, or they may be transferred separately to the mixers 40 and 42.

The optional dewatering apparatus 50 is selected from any number of existing systems that take a cellulose pulp slurry and remove water to a desired solids content. Any type of screw press, twin wire press, vacuum filter, plate, and frame press, roll press, or centrifugal drum, for example, can be used as the dewatering apparatus 80. The optional dewatering system 50 may increase the solids content of the slurry containing the fibers to about 30% or more but not limited thereto.

A pump or other form of material transfer mechanism can be used to transfer dewater effluent to the save-all 60, which separates fibers from fluid. This can be accomplished by a flotation, rotary (vacuum filters) or wire (fabric) system that can efficiently remove the fluid. The fibers from the save-all are moved to a recovered wet fiber container. Excess fluid from the save-all 60 can be filtered for use in other process components of the system or put into a waste treatment process for removal.

The optional fluffer/chopper apparatus 80 is configured to break up a pulp cake of treated fibers or optionally dewatered treated fibers. The apparatus 80 can be two counter rotating meshed blades with a discharge to the drying apparatus 90. Any number of fluffers can be used to break up the pulp cake. The pulp cake can be broken up ahead of the mixer 40/42 or internally within the mixer 40/42 by blades internal to the mixer 40/42 that may be designed to separate fibers.

The drying apparatus 90 is used to dry the fibers from mixers 40 and 42 down to a desired moisture content, which may range from 8-25% in moisture content (75-92% solids), for example, but not limited thereto. A dryer, such as but not limited to a rotary drum dryer or flash dryer system that breaks up and fluffs the pulp while drying may be advantageous, but other drying systems such as microwave dryers and conveyorized dryers may also be employed. A belt conveyor, auger system or other form of conveyance device may be used to transport the dried and chemically treated fibers to a location for cooling. An exhaust gas/hot air collection system from the dryer system may be employed to take moist air and recirculate it back through the drying apparatus 90 to capture residual heat before exhausting to the atmosphere.

An optional dry fluffer 160 may be used to separate clumps of materials that may have formed in the drying process, while minimally affecting the basic structure of the fibers and while retaining desired fiber superstructures when such superstructures form part of the end product. Alternatively, the optional fiberizer 110 may be used as a more aggressive measure to further refine the treated and dried fibers, by further separating and reducing the size of the fibers after the drying process. Those separated fibers and/or fiber superstructures may optionally be further classified by size using the dry classifier 120. The dry fluffer 160 and the fiberizer 110 can be mechanical devices with rotating toothed plates in close proximity to one or more sets of static or counter rotating toothed plates such that when clumps of fibers are conveyed through the device 160/110, they are subjected to shear forces which separate the fibers. The distinction between a fluffer and a fiberizer is in the severity of their interaction with the materials, with a fluffer more gently separating groups or clumps of fibers and a fiberizer more aggressively impacting the materials with greater shear (and focused on separating individual fibers). A hammermill is an example of a fiberizer, but there are also other types of fiberizers such as those formed with one or more rotating toothed plates in close proximity to one or more stationary or counterrotating toothed plates. Traditional fiberizers used to make cellulose insulation with dry fire retardants mix the chemical and fiber in a high velocity grinding motion, which can have the effect of pressing chemicals onto the fibers and creating adhesion. That is, the fiberizer 110 may be used as the applicator 140. Shredders may also be employed.

The optional chopper 80 may be used instead of the optional fiberizer 110 but it is used prior to drying the treated fibers. In that way, dust formation is reduced as compared to when the fiberizer 110 is used after drying. The use of the chopper 80 breaks up the clumps in a way that is different from the fiberizing and post-drying separation described. Specifically, because wetted fibers are moist, they are more pliable and less susceptible to breakage. Further, fibers may be combined with one or more binders to form superstructures before chopping. The binder may be a chemical additive suitable for joining fibers together, and a suitable binder may be a starch, adhesive, or other binder. These superstructures may have spaced bonds between fibers and/or fiber particulates that establish voids for improving insulative and density characteristics and those bonds may be formed directly or through use of an optional binder. The use of the chopper 80 instead of the fiberizer 110 can improve the likelihood of maintaining superstructure integrity because the fibers are more pliable and less fragile in a moist or wet state.

Fibers of the insulation of the present invention may optionally be sent for testing. Testing may be performed on the fibrous material that is the hybrid fire retardant cellulose insulation of the present invention for compliance with all regulations concerning blown-in cellulosic fiber insulation as directed by the C-739, HH 1515, and the Consumer Product Safety Council. The treated fibers made using the method of the present invention can be used as a fire retardant, thermal, sound, and radiant barrier material for insulating.

In addition to being used to separate fibers with differing characteristics, the partitioning device 30 can also separate contaminants from the fibers of the feedstocks. These contaminants of the recycled feedstock material 10 may include glass, plastic, or other non-cellulose elements, for example. The partitioning device 30 may be comprised of a screening system, or a cyclonic separator, which are two examples of partitioning technologies that may be applicable. The partitioning device 30 may additionally include or instead be a screening apparatus such as the type shown at: https://www.andritz.com/products-en/group/pulp-and-paper/pulp-production/kraft-pulp/pulp-drying-finishing/pulp-screening-cleaning, for example, to facilitate fiber classification prior to introducing the feedstock materials into the mixers 40 and 42.

The optional dry classifier 120 may be used to separate by size treated and dried fibers so that relatively small particulates that are effectively dust particles are removed from the product to minimize dust inclusion in the finished product. The dry classifier 120 may be a screening apparatus or an air classifier. An air classifier may use an upward airflow to separate lighter elements from heavier elements, for example. The dry classifier 120 may operate to separate fibers based on size, density, hydrodynamic diameter, or other characteristics proven to separate high performing product from less desirable fractions of the product.

An embodiment of the hybrid fire retardant cellulose insulation of the present invention may be created with the feedstock options described herein but without processing the dry-treated feedstock through the mixer 40. Instead, dry-treated feedstock may simply be shredded or otherwise processed to reduce its size, if needed, and is then delivered to the dry fire retardancy material applicator 140 but without any sort of wet treatment prior to that delivery. That option is represented in FIG. 1 with optional pathway 200.

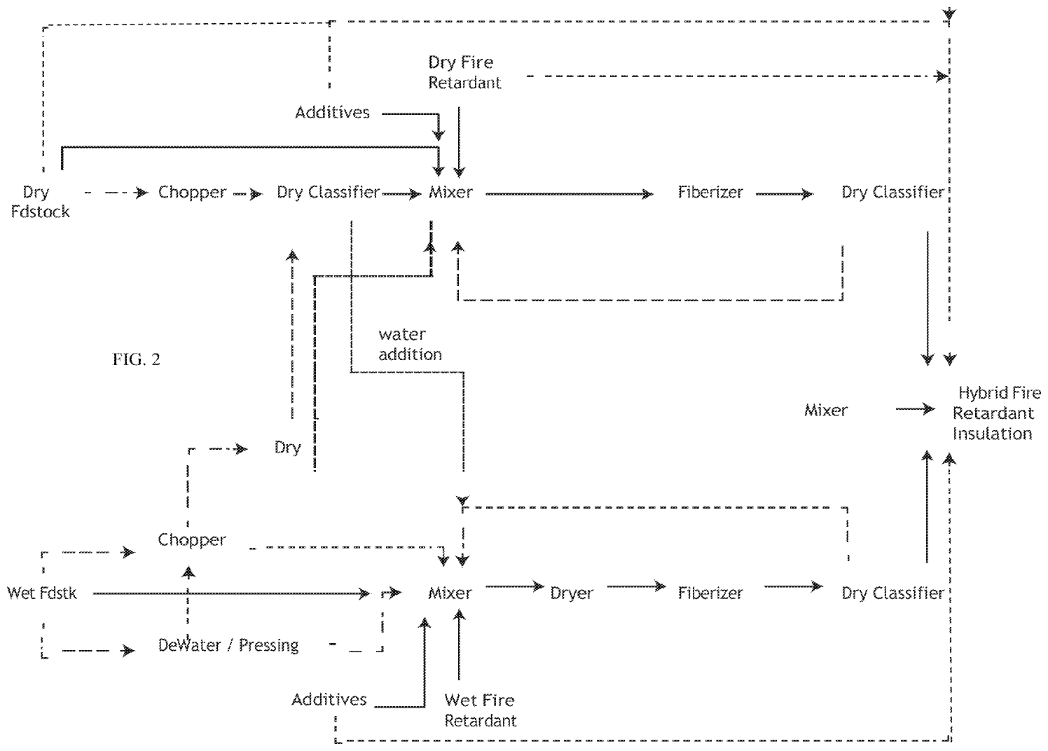

FIG. 2 provides a second representation of primary steps and components of a system and a method for making the hybrid fire retardant insulation of the present invention. One or more feedstock components that have been or that are separated into a first portion and a second portion are processed as described with respect to FIG. 2. The first portion is a wet feedstock, and the second portion is a dry feedstock. The wet feedstock is transferred to a wet fire retardant mixer 100 into which is added a wet fire retardant as previously described herein and one or more additives. The mixing of the wet feedstock and the wet fire retardant in the mixer 100 enhances the integration of the fire retardant into the fibers of the wet feedstock. Optionally, the wet feedstock may be chopped and/or dewatered/pressed before introduction to the mixer 100. Further, a portion of the chopped wet feedstock may be dried and transferred to another mixer, such as the mixer used in the dry feedstock processing.

With continuing reference to FIG. 2, the fire retardant treated wet feedstock is dried in a drier, fiberized, and dry classified. A portion of the dry classified treated wet feedstock may be returned to the mixer 100. All or a second portion of the dry classified wet feedstock is transferred to hybrid insulation mixer 102.

At the same or a different time that the wet feedstock is being processed, the dry feedstock is transferred into dry mixer 104. A dry fire retardant material such as has been described herein and one or more additives are also transferred into the mixer 104 where they are mixed together so that the dry fire retardant material coats the surface of fibers of the dry feedstock. It is noted that a portion or all of the dry feedstock may be chopped and classified prior to transfer to the mixer 104. Any optionally dry classified dry feedstock may be wetted and transferred to the wet mixer 100. Also, any wet feedstock may be treated with dry fire retardant material. The mixed dry feedstock is then fiberized and then dry classified. A portion of the dry classified treated dry feedstock may be returned to the mixer 104. All or a second portion of the dry classified dry feedstock is transferred to the hybrid insulation mixer 102. It is noted that a portion of the dry feedstock may be transferred directly to the hybrid insulation mixer 102. One or more additives of either or both of the wet feedstock processing and the dry feedstock processing may be added to the hybrid insulation mixer 102.

The treated wet feedstock that has been dried and classified, and the treated dry feedstock that has been classified, along with any other additives that are optionally added, are mixed together in the hybrid insulation mixer 102 to produce the hybrid insulation of the present invention. The components of the system represented in FIG. 2 may be the same as described with respect to the discussion of the system of FIG. 1. Those of skill in the art will recognize that other devices may be used to carry out the steps described in making the hybrid fire retardant insulation.

The invention has been described with respect to representative examples and is not intended to be limited thereto. Instead, the invention is defined by the appended claims and all reasonable equivalents.

What is claimed is:

1. An insulation product comprising:
one or more feedstock components, wherein a first portion of the one or more feedstock components is treated with wet fire retardancy material to integrate the wet fire retardancy material within fibers of the first portion of the one or more feedstocks, and a second portion of the one or more feedstock components is treated with dry fire retardancy material.

2. The insulation product of claim 1, wherein at least some of the one or more feedstock components of the second portion are in a wet condition when treated with the dry fire retardancy material.

3. The insulation product of claim 1, wherein the one or more feedstock components include cellulose fibers that are wet when treated with the wet fire retardancy material.

4. The insulation product of claim 3, wherein the wet cellulose fibers contain between about 25% and about 75% by weight of moisture when treated with the wet fire retardancy material.

5. The insulation product of claim 1, wherein the one or more feedstock components include one or more cellulose feedstocks, one or more agricultural fiber sources and combinations thereof.

6. The insulation product of claim 1, wherein the one or more feedstock components include cellulose fibers, wherein the cellulose fibers are sourced from one or more of corrugated board, liner board, Old Corrugated Containers, Old Newsprint, recycled cellulose, virgin kraft pulp, virgin ground wood pulp, sawdust, wood chips, pine chips, and combinations thereof.

7. The insulation product of claim 1, wherein the one or more feedstock components include agricultural fibers, wherein the agricultural fibers are sourced from one or more of straw, wheat, rice hulls, feathers, hemp, and combinations thereof.

8. The insulation product of claim 1, wherein the wet fire retardancy material and the dry fire retardancy material are selected from one or more of boric acid, borax, poly-hydrated boron compounds, sodium tetraborate, ammonium sulfate, magnesium sulfate, calcium sulfate, zinc sulfate, ferrous sulfate, and mixtures thereof.

9. The insulation product of claim 1, wherein at least some of the one or more feedstock components of the second portion are treated with a loading of the dry fire retardancy material of about 3% to about 20% by weight on a dry weight percent basis.

10. The insulation product of claim 9, wherein the fire retardancy material loading is about 5% to about 12%.

11. The insulation product of claim 1 further comprising one or more additives.

12. The insulation product of claim 11, wherein the one or more additives are selected from the group consisting of one or more biocides, one or more enzymes, one or more fungicides, one or more lubricants, one or more bonding agents, or any combination thereof.

13. The insulation product of claim 1, wherein at least some of the one or more feedstock components of the second portion are in a dry condition when treated with the dry fire retardancy material.

14. The insulation product of claim 13, wherein the at least some of the one or more feedstock components of the second portion in a dry condition are treated with a dry fire retardancy material loading of about 3% to about 25% by weight on a dry weight percent basis.

15. The insulation product of claim 14, wherein the fire retardancy material loading is about 7% to about 18%.

16. The insulation product of claim 1, wherein the one or more feedstock components is a combination of dry treated feedstock and wet treated feedstock.

17. The insulation product of claim 16, wherein a ratio of dry treated feedstock to wet treated feedstock is in a range of about 10% to about 90% to about 90% to about 10% by weight.

18. A method of producing an insulation product from one or more feedstock components of which at least one is a cellulose feedstock component, the method comprising the steps of:
treating a first portion of the one or more feedstock components with wet fire retardancy material to integrate the wet fire retardancy material within fibers of the first portion of the one or more feedstocks;
treating a second portion of the one or more feedstock components with dry fire retardancy material;
drying the first portion of the one or more feedstock components after the step of treating with the wet fire retardancy material; and
combining the treated and dried first portion with the treated second portion.

19. The method of claim 18, further comprising the step of treating at least a portion of the first portion of the one or more feedstock components with the dry fire retardancy material.

20. The method of claim 18, wherein the cellulose feedstock component includes cellulose fibers that are wet when treated with the wet fire retardancy material.

21. The method of claim 20, wherein the wet cellulose fibers contain between about 25% and about 75% by weight of moisture when treated with the wet fire retardancy material.

22. The method of claim 18, wherein the one or more feedstock components include one or more cellulose feedstocks, one or more agricultural fiber sources and combinations thereof.

23. The method of claim 18, the cellulose feedstock component is sourced from one or more of corrugated board, liner board, Old Corrugated Containers, Old Newsprint, recycled cellulose, virgin kraft pulp, virgin ground wood pulp, sawdust, wood chips, pine chips, and combinations thereof.

24. The method of claim 18, wherein the one or more feedstock components include agricultural fibers, wherein the agriculture fibers are sourced from one or more of straw, wheat, rice hulls, feathers, hemp, and combinations thereof.

25. The method of claim 18, wherein the fire retardancy material is selected from one or more of boric acid, borax, poly-hydrated boron compounds, sodium tetraborate, ammonium sulfate, magnesium sulfate, calcium sulfate, zinc sulfate, ferrous sulfate, and mixtures thereof.

26. The method of claim 18, wherein at least some of the one or more feedstock components of the second portion are treated with a loading of the dry fire retardancy material of about 3% to about 20% by weight on a dry weight percent basis.

27. The method of claim 26, wherein the dry fire retardancy material loading is about 5% to about 12%.

28. The method of claim 18, further comprising the step of adding one or more additives to either or both of the first portion of the one or more feedstock components while treating with the wet fire retardancy material and the second portion of the one or more feedstock components while treating with the dry fire retardancy material.

29. The method of claim 28, wherein the one or more additives are selected from the group consisting of one or more biocides, one or more enzymes, one or more fungicides, one or more lubricants, one or more bonding agents, or any combination thereof.

30. The insulation product of claim 1, wherein at least some of the one or more feedstock components of the second portion are in a dry condition when treated with the dry fire retardancy material.

31. The method of claim 18, wherein a ratio of dry treated feedstock to wet treated feedstock is in a range of about 10% to about 90% to about 90% to about 10% by weight.
